(19) United States
(12) Patent Application Publication
(10) Pub. No.: US 2009/0214219 A1
(43) Pub. Date: Aug. 27, 2009

(54) Electronic apparatus

(75) Inventors: Atsushi Misawa, Miyagi (JP); Naoyuki Nishino, Kanagawa (JP); Takeshi Misawa, Miyagi (JP); Eiji Ishiyama, Miyagi (JP); Yasunori Ohta, Kanagawa (JP)

Correspondence Address: Moss & Burke, PLLC, 401 Holland Lane, Suite 407, Alexandria, VA, 22314, US

(73) Assignee: FUJIFILM CORPORATION, Tokyo (JP)

(21) Appl. No.: 12/379,333

(22) Filed: Feb. 19, 2009

(30) Foreign Application Priority Data
Feb. 22, 2008 (JP) 2008-041546

(51) Int. Cl. H04B 10/00; G02F 1/00

(52) U.S. Cl. 398/128; 359/237

(57) ABSTRACT

An electronic apparatus includes a housing that has a first concave section, a first emission unit that emits a laser beam into the first concave section, and a first modulator that modulates the laser beam emitted from the first emission unit in accordance with transmission information. The first emission unit is disposed so as not to emit at least a direct beam of the emitted laser beam to the outside of the first concave section.

### CROSS-REFERENCE TO RELATED APPLICATION

This application claims priority under 35 USC 119 from Japanese Patent Application No. 2008-041546, the disclosure of which is incorporated by reference herein.

### BACKGROUND OF THE INVENTION

1. Field of the Invention

The present invention relates to an electronic apparatus, and more particularly, to an electronic apparatus transmitting and receiving information by the use of a laser beam that has been modulated in accordance with transmission information.

2. Description of the Related Art

In recent years, a technique of making a radio communication at a very high transfer rate (for example, 1 Gb/s) using a laser beam in an infrared wavelength range was suggested (see “The Realization of Infrared Wireless Communication at a Transmission Speed of 1 Gbit/s Using a Mobile Telephone,” KDDI R&D Laboratories, INC., http://www.kddilabs.jp/press/img/83_{—}1.pdf). By employing this technique, in transmitting and receiving data between electronic devices, it is possible to completely transmit and receive a large amount of data for a short time without connecting the electronic devices transmitting and receiving data each other through a communication cable or the like even when at least one electronic device has portability and transmits and receives a large amount of data. Accordingly, this technique can be used in various applications such as greatly reducing the communication time for a radio communication between devices or transmitting and receiving a large amount of data between devices, which have not been assumed for use in the radio communication.

For example, Japanese Patent No. 3494683 discloses a radiation detector cassette (also referred to as electronic cassette) having a configuration in which a radiation detector and an image memory are built therein, a radiographic image detected by the radiation detector is stored as image data in the image memory, and the image data read from the image memory is converted into radio signals and is output to an external signal processing circuit. Since plural devices, which are not suitable for an environment where electric waves are radiated, exist in medical sites, the radio communication suitable for the cassette was limited to an infrared communication based on an infrared data association (IrDA) standard in the past. However, since the communication speed is about 115 kb/s to 6 Mb/s in the infrared communication based on the IrDA standard but the reversible compression having a low compression rate is selected for compressing image data to prevent the bad influence on reading images in such a type of medical devices, a very long time is required for transmitting the image data. On the contrary, when the above-mentioned communication using a laser beam is employed as the radio communication in the cassette, it is possible to greatly reduce the transfer time for the image data.

Japanese Patent Application Laid-Open (JP-A) No. 2007-81134 discloses an optical communication module having a laser diode disposed in a lead housing and a transparent resin section as an adjuster for carrying out optical output distribution extension and output adjustment of the laser diode, where the transparent resin section includes a transparent resin sealing the laser diode and a glass filler which is added to the transparent resin to be substantially uniformly distributed in the entire transparent resin and which exhibits a light transmitting and diffusing function.

When electronic apparatuses make a radio communication with each other using a laser beam and at least one electronic apparatus has portability, the radio communication is made when both electronic apparatuses are arranged in a positional relation where both can make the radio communication using a laser beam. However, since at least one electronic apparatus has the portability, the relative position between both electronic apparatuses varies with an external force such as a pressing force or vibration applied to the housing of the electronic apparatus in communication using a laser beam and the variation in relative position may cause leakage of the laser beam from a space between both electronic apparatuses.

On the contrary, in the technique described in JP-A No. 2007-81134, the extension of a light output distribution of an optical communication module and the decrease in light output intensity of the optical communication module are realized by repeating the refraction of light from the laser diode by the use of a glass filler. Here, the leakage of the laser beam is not considered at all when the relative position between the electronic apparatuses in communication using the laser beam varies.

### SUMMARY OF THE INVENTION

The present invention has been made in view of the above circumstances and provides an electronic apparatus.

A first aspect of the present invention provides an electronic apparatus includes a housing that has a first concave section, a first emission unit that emits a laser beam into the first concave section, and a first modulator that modulates the laser beam emitted from the first emission unit in accordance with transmission information. The first emission unit is disposed so as not to emit at least a direct beam of the emitted laser beam to the outside of the first concave section.

A second aspect of the present invention provides an electronic apparatus includes a first apparatus and a second apparatus. A first apparatus includes a housing that has a first concave section, a first emission unit that emits a laser beam into the first concave section, and a first modulator that modulates the laser beam emitted from the first emission unit in accordance with transmission information. The second apparatus includes a housing and a reception unit. When a relative position between the housing of the first apparatus and the housing of the second apparatus is adjusted to a communicable position where the laser beam emitted from the first emission unit is incident on a light-receiving area of the second apparatus, the reception unit of the second apparatus receives the transmission information by detecting the laser beam incident on the light-receiving area and demodulating the transmission information from the detection result of the laser beam. The first emission unit is disposed so as not to emit at least a direct beam of the emitted laser beam to the outside of the first concave section. The light-receiving area of the second apparatus is disposed in a portion, which is inserted into the first concave section and to which the laser beam emitted from the first emission unit is applied, in the housing of the second apparatus when the relative position between the housing of the second apparatus and the housing of the first apparatus is adjusted to the communicable position.

### BRIEF DESCRIPTION OF THE DRAWINGS

FIG. 1 is a block diagram schematically illustrating configurations of an electronic cassette and an image reader according to an embodiment of the invention.

FIG. 2A is a diagram schematically illustrating an arrangement of the electronic cassette at the time of taking a radiological image, and FIG. 2B is a perspective view illustrating an internal structure of the electronic cassette.

FIGS. 3A and 3B are perspective views illustrating appearances of the electronic cassette and the image reader.

FIGS. 4A to 4C are side views illustrating a lid section closing an opening of an insertion groove of the image reader.

FIG. 5A is a perspective view illustrating a protruding portion disposed in the insertion groove of the image reader, and FIG. 5B is a perspective view illustrating a groove which is disposed in a housing of the electronic cassette and which the protruding portion is inserted into.

FIGS. 6A to 6D are side views illustrating an insertion of the protruding portion of the image reader into the groove of the electronic cassette at the time of setting the electronic cassette to the image reader.

FIGS. 7A to 7C are diagrams schematically illustrating a supply of power between the electronic cassette and the image reader.

FIGS. 8A and 8B are diagrams schematically illustrating an example where a reflecting member is disposed on an outer surface of a lid section closing the groove of the electronic cassette.

FIGS. 9A and 9B are diagrams schematically illustrating an example where the invention is applied to a digital still camera and a cradle.

FIG. 10 is a diagram schematically illustrating another example where the invention is applied to a digital still camera and a cradle.

### DETAILED DESCRIPTION OF THE INVENTION

Hereinafter, embodiments of the invention are described in detail with reference to the drawings.

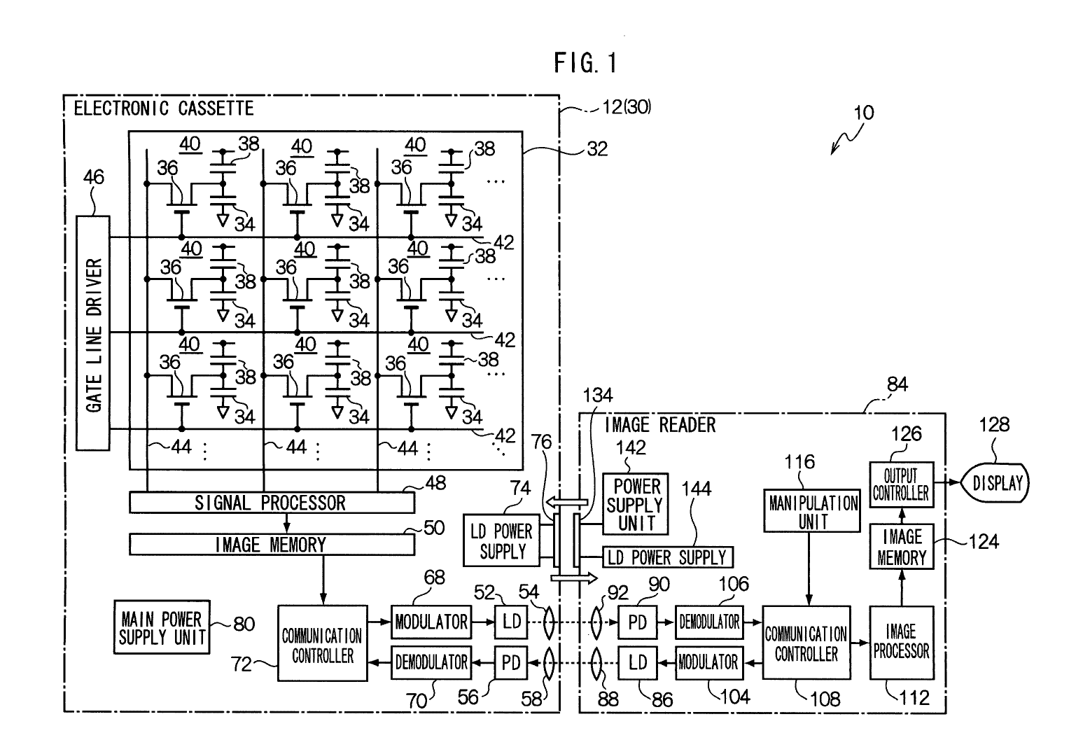

FIG. 1 illustrates a radiographic image treating system 10 according to a first embodiment. The radiographic image treating system 10 includes an electronic cassette 12 having portability and being capable of converting image information into image data and storing the image data every time a radiation carrying the image information is radiated and an image reader 84 capable of reading the image data stored in the electronic cassette 12. The electronic cassette 12 corresponds to a portable radiographic image converter and the image reader 84 corresponds to an image reader.

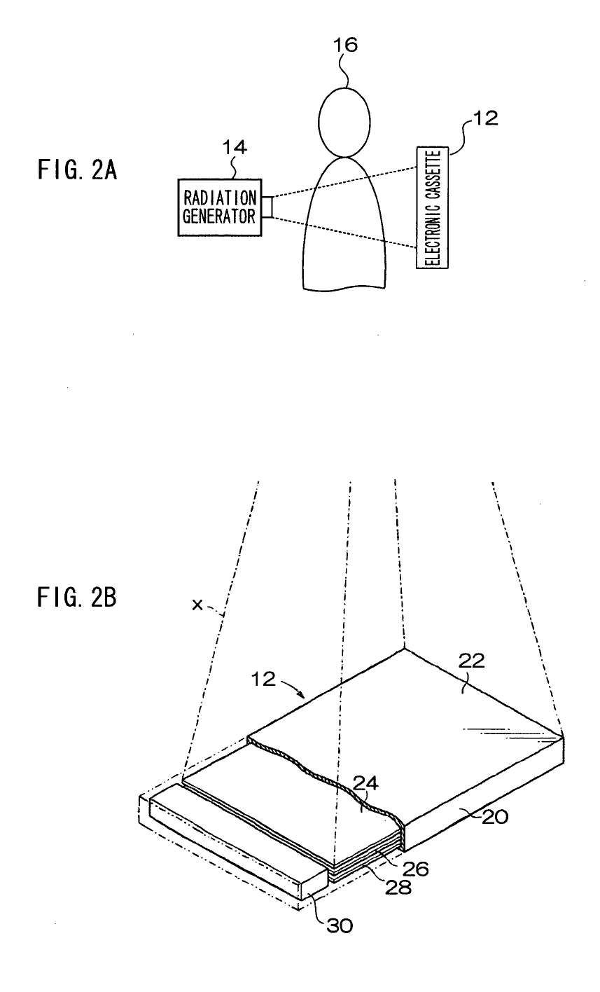

As shown in FIG. 2A, the electronic cassette 12 is disposed with a gap from a radiation generator 14 generating a radiation such as X-rays at the time of taking a radiographic image. A photographing position for a subject 16 is set between the radiation generator 14 and the electronic cassette 12. When it is instructed to take a radiographic image, the radiation generator 14 emits a radiation with a radiation intensity corresponding to a predetermined photographing condition. The radiation emitted from the radiation generator 14 is transmitted by the subject 16 located at the photographing position to carry image information and then is applied to the electronic cassette 12.

As shown in FIG. 2B, the electronic cassette 12 is formed of a material transmitting a radiation X and is covered with a panel-like casing (housing) 20 having a thickness. In the casing 20, a grid 24 removing a scattered radiation of the radiation X resulting from passing through the subject 16, a radiation detector (radiation detecting panel) 26 detecting the radiation X, and a lead plate 28 absorbing a back scattered radiation of the radiation X are sequentially arranged from an irradiated surface 22 of the casing 20 irradiated by the radiation X. The irradiated surface 22 of the casing 20 may be formed of the grid 24. A case 30 for receiving various circuits (to be described later) including a micro computer is disposed at one end in the casing 20. To prevent various circuits received in the case 30 from being damaged by the application of the radiation X, a lead plate or the like may be disposed on the side of the case 30 close to the irradiated surface 22.

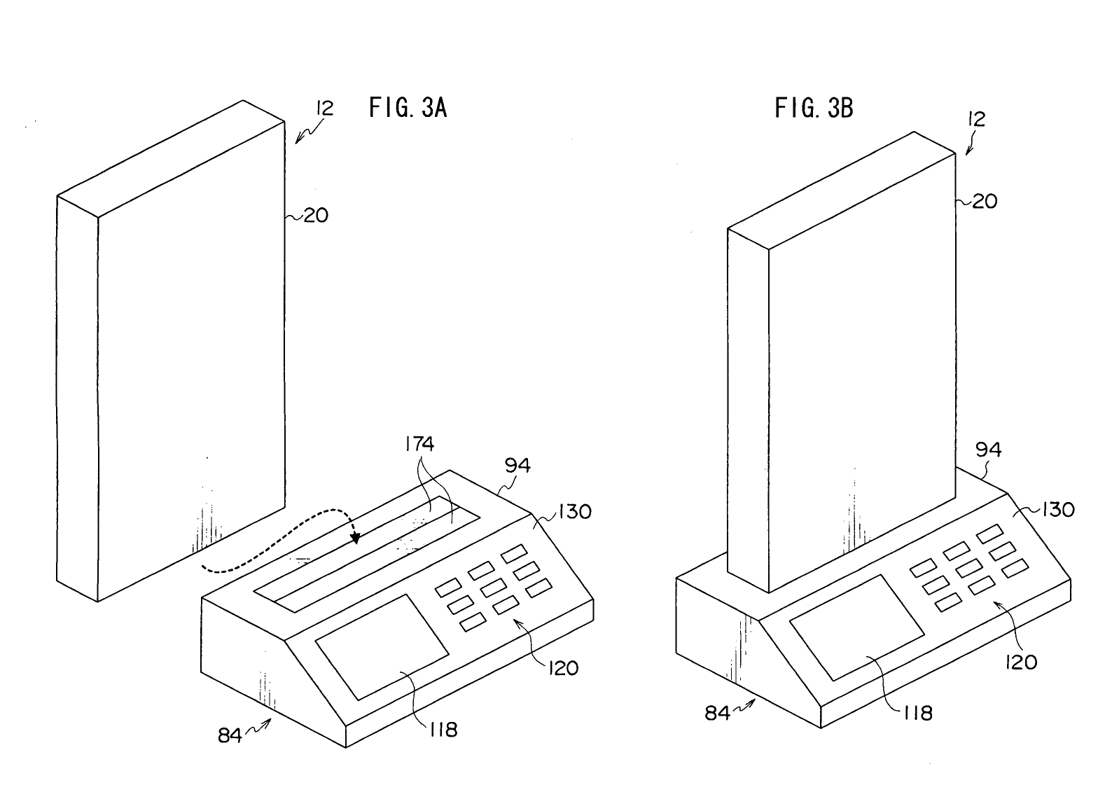

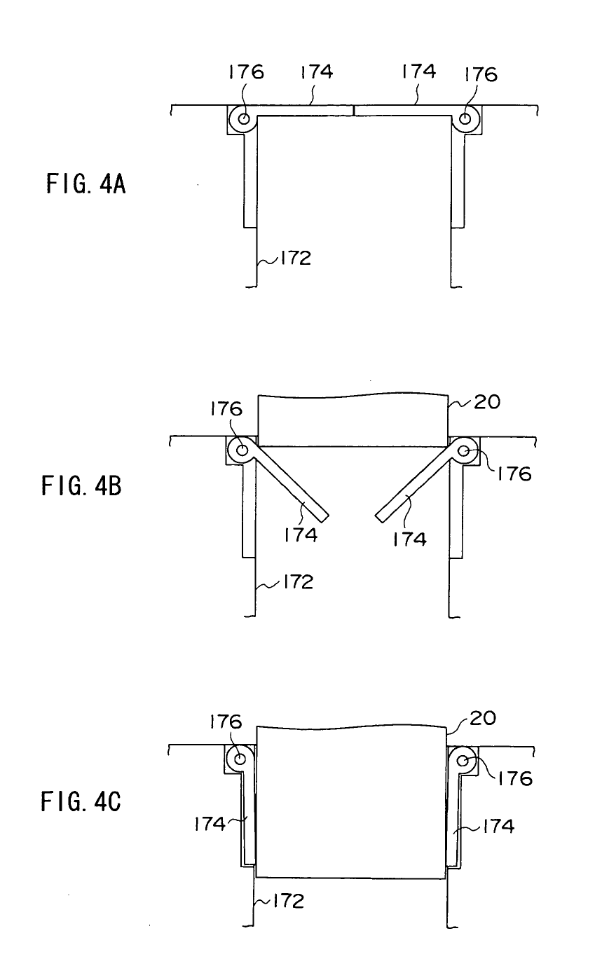

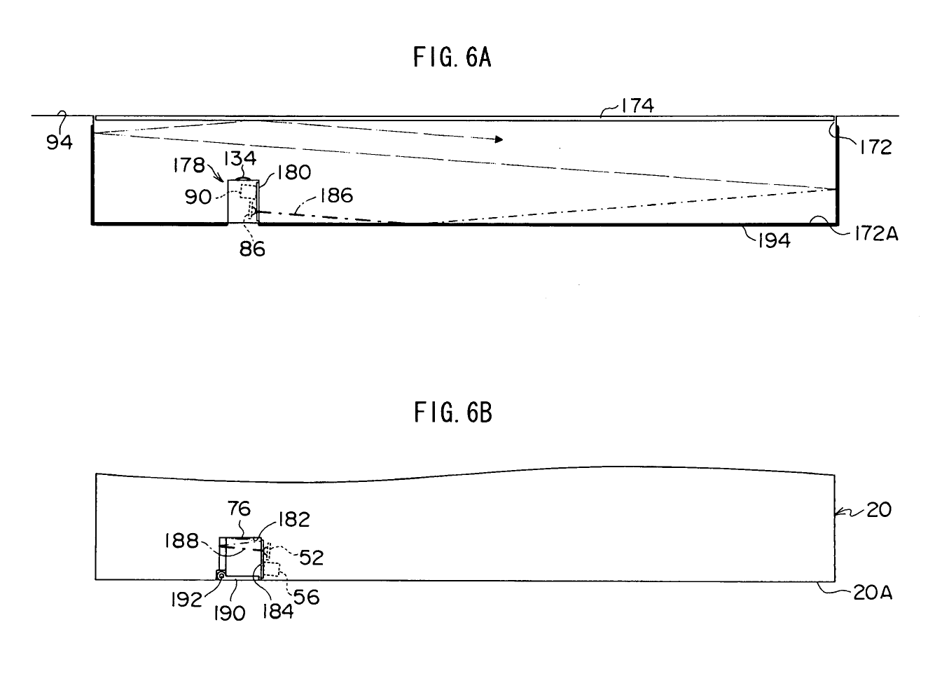

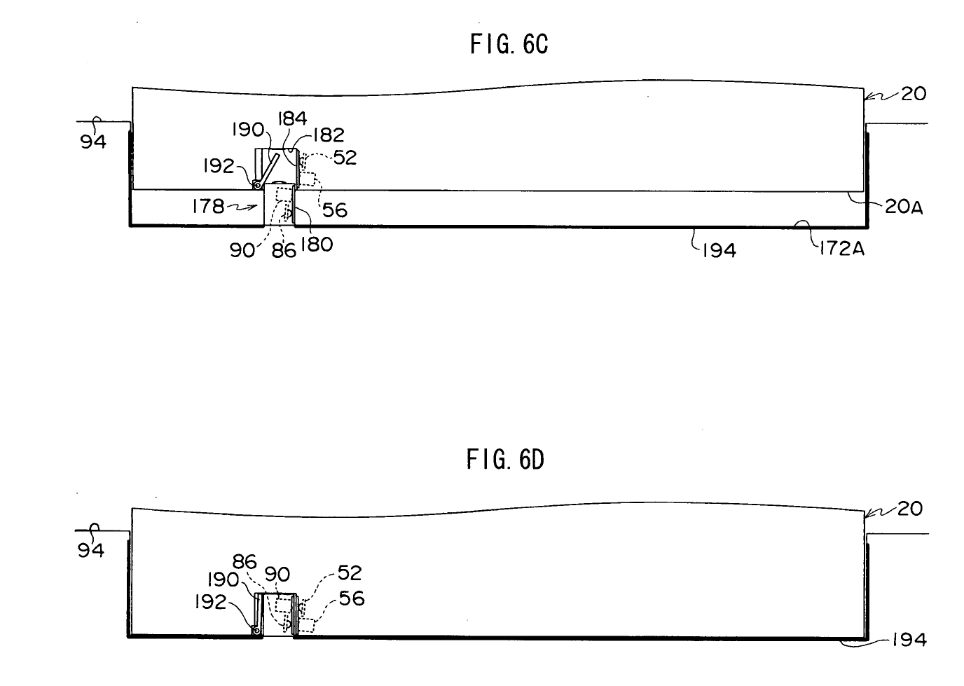

On the other hand, as shown in FIGS. 3A and 3B, the casing 94 of the image reader 84 has a shape obtained by obliquely cutting a part of a rectangular shape, a manipulation panel 130 is disposed on a slope of the casing 94, and an insertion groove 172 (see also FIGS. 4A to 4C) is formed on the top surface of the casing 94. The insertion groove 172 has a rectangular opening and a size capable of inserting the casing 20 of the electronic cassette 12. When the image reader 84 is made to read image data from the electronic cassette 12, the casing 20 of the electronic cassette 12 is inserted into the insertion groove 172 of the image reader 84 when one side surface (referred to as “bottom surface 20A” in this embodiment) of the casing 20 having the case 30 disposed thereon is directed downward and the bottom surface 20A of the casing 20 of the electronic cassette 12 comes in contact with a bottom 172A (see FIG. 6A) of the insertion groove 172, whereby when a part of the bottom surface 20A of the casing 20 is inserted into the insertion groove 172 is maintained as shown in FIG. 3B.

A pair of longitudinal lid sections 174 is disposed in the opening of the insertion groove 172. As shown in FIGS. 4A to 4C, the lid sections 174 are pivotally supported by the casing 94 with rotation shafts 176 and are maintained at closing positions (see FIG. 4A) where the opening of the insertion groove 172 is closed by a biasing force from a biasing member which is not shown. Here, when the casing 20 of the electronic cassette 12 is inserted into the insertion groove 172, corners coming in contact with the bottom surface 20A of the casing 20 first comes in contact with the lid sections 174 and then the lid sections 174 are pressed by the corners of the casing 20 with the downward movement of the casing 20, whereby the lid sections 174 rotates in a direction where the opening of the insertion groove 172 is opened against the biasing force of the biasing member as shown in FIG. 4B. When the casing 20 moves further downward, as shown in FIG. 4C, the lid sections 174 completely retreat from the insertion groove 172 and thus the casing 20 can be inserted into the insertion groove 172 up to the position (the communicable position) where the bottom surface 20A of the casing 20 comes in contact with the bottom 172A of the insertion groove 172.

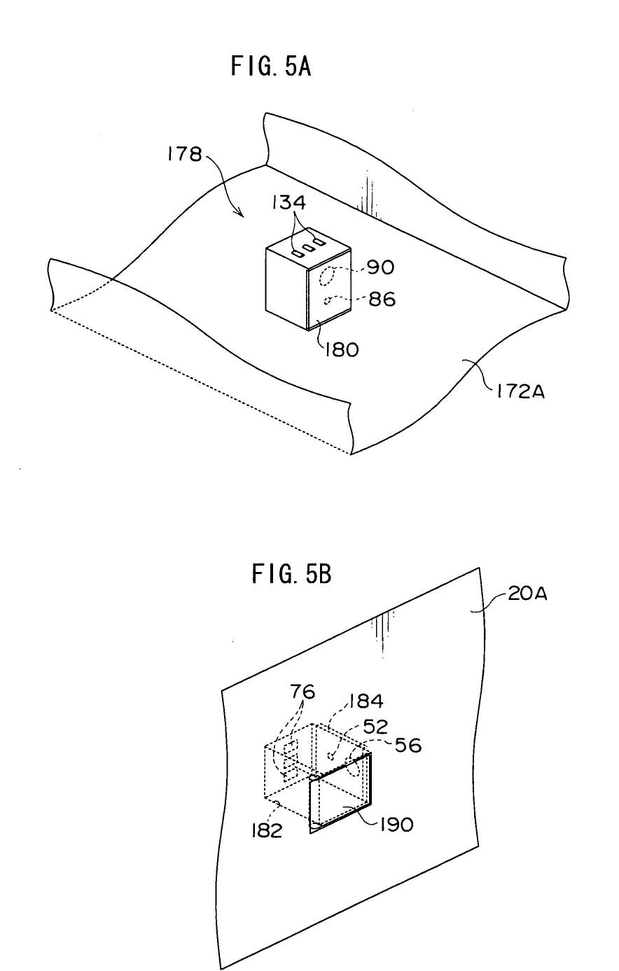

A rectangular protruding portion 178 is formed upright on the bottom 172A of the insertion groove 172 of the image reader 84 as shown in FIG. 5A. A groove 182 having a rectangular opening and a size capable of receiving the protruding portion 178 when the casing 20 of the electronic cassette 12 is inserted into the insertion groove 172 up to the communicable position is disposed in the bottom surface 20A of the casing 20 of the electronic cassette 12 as shown in FIG. 5B.

The image reader 84 according to this embodiment has a function of making a radio communication with the electronic cassette 12 using a laser beam. An LD 86 as a laser source and a PD 90 detecting a laser beam incident from the outside are disposed in the protruding portion 178 as shown in FIG. 6A. A plate-like transparent member 180 is attached to a specific side surface of four side surfaces of the protruding portion 178. The LD 86 emits a laser beam through the transparent member 180 and the PD 90 is disposed in the protruding portion 178 so as to receive the laser beam passing through the transparent member 180 (the transmission position of the laser beam emitted from the LD 86 in the transparent member 180 is referenced by reference numeral “86” and the transmission position of the laser beam received by the PD 90 in the transparent member 180 is referenced by reference numeral “90” in FIG. 5A). Plural electrical contacts 134 (for example, three or more) are disposed on the top surface of the protruding portion 178.

The electronic cassette 12 according to this embodiment has a function of making a radio communication with the image reader 84 using a laser beam. As shown in FIG. 6B, an LD 52 as a laser source and a PD 56 detecting a laser beam incident from the outside are disposed on one side of the groove 182. A plate-like transparent member 184 is attached to a specific side surface, which is opposed to the side surface of the protruding portion 178 to which the transparent member 180 is attached when the casing 20 of the electronic cassette 12 is inserted into the insertion groove 172 up to the communicable position, of four side surfaces of the groove 182, similarly to the protruding portion 178. The LD 52 emits a laser beam through the transparent member 184 and the PD 56 is disposed at a predetermined position on a side of the groove 182 so as to receive the laser beam passing through the transparent member 184 (the transmission position of the laser beam emitted from the LD 52 in the transparent member 184 is referenced by reference numeral “52” and the transmission position of the laser beam incident on the PD 56 in the transparent member 184 is referenced by reference numeral “56” in FIG. 5A). The same number of electrical contacts 76, which come in contact with the electrical contacts 134 when the casing 20 of the electronic cassette 12 is inserted into the insertion groove 172 up to the communicable position and the protruding portion 178 is inserted into the groove 182, as the electrical contacts 134 are disposed on the bottom surface of the groove 182.

Accordingly, when the casing 20 of the electronic cassette 12 is inserted into the insertion groove 172 up to the communicable position and the protruding portion 178 is inserted into the groove 182, as shown in FIG. 6D, the LD 52 of the electronic cassette 12 is opposed to the PD 90 of the image reader 84 with the transparent members 180 and 184 and the LD 86 of the image reader 84 is opposed to the PD 56 of the electronic cassette 12 (in this state, the radio communication can be made using a laser beam). In this state, the electrical contacts 134 come in contact with the electrical contacts 76, respectively, and thus the individual electrical contacts 134 are electrically connected to the individual electrical contacts 76.

In the LD 86 of the image reader 84, the emission direction of the laser beam is oblique about the opening surface and the bottom 172A of the insertion groove 172. Specifically, the direction is adjusted so as to emit a laser beam along an optical path 186 (see FIG. 6A) in which a distance from the opening of the insertion groove 172 increases (the distance from the bottom 172A decreases) as it gets apart from the LD 86. The PD 56 of the electronic cassette 12 is slightly oblique to correspond to the emission direction of the laser beam from the LD 86. In the LD 52 of the electronic cassette 12, the emission direction of the laser beam is oblique about the opening surface of the groove 182. Specifically, the direction is adjusted so as to emit a laser beam along an optical path 188 (see FIG. 6B) in which a distance from the opening of the groove 182 increases as it gets apart from the LD 52. The PD 90 of the image reader 84 is slightly oblique to correspond to the emission direction of the laser beam from the LD 52.

In order to enhance a communication speed between the electronic cassette 12 and the image reader 84, it is preferable that the LDs 52 and 86 are LDs emitting a laser beam having a wavelength in an infrared region and the PDs 56 and 90 are PDs having sensitivity to a wavelength in the infrared region.

As shown in FIG. 6B, the opening of the groove 182 is provided with a lid section 190. The lid section 190 is pivotally supported by the casing 20 with a shaft 192 and is maintained in a closing position (see FIG. 6B) where the opening of the groove 182 is closed by a biasing force from a biasing member which is not shown. Here, when the protruding portion 178 is inserted into the groove 182, corners of the protruding portion 178 first comes in contact with the lid section 190 and the lid section is pressed by the corners of the protruding portion 178 with the downward movement of the casing 20, whereby the lid section 190 rotates in a direction in which the opening of the groove 182 is opened against the biasing force of the biasing member as shown in FIG. 6C. When the casing 20 moves further downward, as shown in FIG. 6D, the lid section 190 completely retreats from the groove 182 and thus the protruding portion 178 can be inserted into the groove 182 up to a position where the electrical contacts 134 comes in contact with the electrical contacts 76, respectively.

In the inner wall surface of the insertion groove 172 of the image reader 84, the almost entire surface other than the portion provided with the protruding portion 178 is covered with a diffusing member 194 diffusing the reflected beam of the applied laser beam by reflecting the applied laser beam in plural directions different from each other. As the diffusing member 194, a member can be used, the surface of which is shaped so that plural portions having different reflecting directions of the laser beam exists in a small area having an area equal to or smaller than the irradiated area of the laser beam. Accordingly, it is possible to satisfactorily diffuse the reflected beam of the laser beam applied to the diffusing member 194. As the diffusion member, a member having a shaped surface can be preferably used, the surface of which is shaped so that semi-spherical convex portions are uniformly distributed on the surface with substantially 1/10 or less of the wavelength of the laser beam. It is possible to reduce the incident angle dependence by setting the convex portions in the semi-spherical shape and to further markedly scatter the laser beam due to the Rayleigh scattering area by setting the size of the individual convex portions to substantially 1/10 or less of the wavelength of the laser beam.

Although not shown, the diffusing member is disposed on the almost entire surface of the inner wall of the groove 182 other than the portion provided with the transparent member 184. The inner surface, which faces the inside of the insertion groove 172 when they are maintained at the closing positions (see FIG. 4A), of the lid sections 174 or the outer surface, which faces the outside of the casing 20 when it is maintained at the closing position (see FIG. 6B), of the lid section 190 is provided with the diffusing member.

Instead of the above-mentioned diffusing member 194, an absorbing member (for example, an optical filter having the wavelength selectivity (specifically, a light absorbing filter having the light absorbing property in the wavelength range of the applied laser beam) or a flocking member or a porous member or a member having a black surface) absorbing most of the applied laser beam may be employed. For example, with a configuration in which a light absorbing material is dispersed in a nitric material, a light absorbing filter having transmittance of about 20% (the optical attenuation ratio per unit length of 1 mm of the optical path is 80%) for the light having a wavelength of 1300 nm which is the wavelength of the laser beam suitable for the communication between the electronic cassette 12 and the image reader 84 is brought to the market. Accordingly, by using the light absorbing filter or performing an AR coating operation on the surface of a light absorbing filter to suppress the surface reflection, the absorbing member suppressing the reflected light to several % of the incident light can be embodied.

Next, structures of electronic systems of the electronic cassette 12 and the image reader 84 are described.

In the radiation detector 26 of the electronic cassette 12, a photoelectric conversion layer absorbing a radiation and converting the absorbed radiation into electric charges is stacked on a TFT active matrix substrate 32 shown in FIG. 1. The photoelectric conversion layer is formed of amorphous selenium (a-Se) containing selenium as a major component (for example, a content of 50% or more) and converts the applied radiation into electric charges by generating electric charges (pairs of electron and hole) of a charge amount corresponding to the intensity of the applied radiation. Plural pixel units 40 (the photoelectric conversion layers corresponding to the pixel units 40 are shown as a photoelectric converter 38 in FIG. 1) each having a storage capacitor 34 accumulating the electric charges generated in the photoelectric conversion layer and a TFT 36 for reading the electric charges accumulated in the storage capacitor 34 are arranged in a matrix on the TFT active matrix substrate 32. The electric charges generated in the photoelectric conversion layer with the application of the radiation to the electronic cassette 12 are accumulated in the storage capacitor 34 of the respective pixel units 40. Accordingly, the image information carried by the radiation applied to the electronic cassette 12 is converted into the charge information and is held by the radiation detector 26.

The TFT active matrix substrate 32 is provided with plural gate lines 42 extending in a predetermined direction (row direction) to turn on and off the TFT 36 of the respective pixel units 40 and plural data lines 44 extending in a direction (column direction) perpendicular to the gate lines 42 to read the accumulated electric charges from the storage capacitor 34 through the turned-on TFT 36. The respective gate lines 42 are connected to a gate line driver 46 and the respective data lines 44 are connected to a signal processor 48. When the electric charges are accumulated in the storage capacitor 34 of the respective pixel units 40, the TFT 36 of the respective pixel units 40 is turned on in the order of rows by a signal supplied from the gate line driver 46 through the gate lines 42 and the electric charges accumulated in the storage capacitors 34 of the pixel units 40 of which the TFT 36 is turned on are transmitted as electric signals to the data lines 44 and are input to the signal processor 48. Accordingly, the electric charges accumulated in the storage capacitor 34 of the respective pixel units 40 are read in the order of rows.

Although not shown, the signal processor 48 has an amplifier and a sampling and holding circuit disposed for the respective data lines 44 and the charge signals transmitted to the respective data lines 44 are amplified by the amplifier and then are held in the sampling and holding circuit. A multiplexer and an A/D converter are sequentially connected to the output side of the sampling and holding circuit. The electric charge signals held in the respective sampling and holding circuits are sequentially (serially) input to the multiplexer and are converted into digital image data by the A/D converters. An image memory 50 is connected to the signal processor 48 and the image data output from the A/D converter of the signal processor 48 are sequentially stored in the image memory 50. The image memory 50 has a memory capacity capable of storing image data corresponding to plural housings and image data taken by photographing are sequentially stored in the image memory 50 every time taking a radiographic image.

The LD 52 of the above-mentioned electronic cassette 12 is connected to a communication controller 72 through a modulator 68. The communication controller 72 is embodied by a microcomputer and serves to output transmission information to the modulator 68 at the time of transmitting information to the image reader 84 and to instruct the intensity of the laser beam emitted from the LD 52 to the modulator 68. The modulator 68 modulates the laser beam emitted from the LD 52 in a predetermined modulation manner in accordance with the input transmission information and controls the driving of the LD 52 so that the intensity of the laser beam emitted from the LD 52 agrees to the instructed intensity. Accordingly, the laser beam that has been modulated in accordance with the transmission information is emitted from the LD 52 with the intensity instructed by the communication controller 72.

The PD 56 of the electronic cassette 12 is connected to the communication controller 72 through a demodulator 70. When the external laser beam is received by the PD 56 and the received intensity signal corresponding to the received intensity of the laser beam is input from the PD 56, the demodulator 70 demodulates the information (information transmitted from an opposite communication apparatus) carried by the received laser beam in a predetermined demodulation manner in accordance with the input received intensity signal and outputs the demodulated information to the communication controller 72. Although not shown in FIG. 6B, a lens 54 is disposed on the laser beam emission side of the LD 52 and a lens 58 is disposed on the laser beam incidence side of the PD 56.

The electronic cassette 12 is provided with a main power supply unit 80. The main power supply unit 80 supplies power to various circuits or elements (such as the gate line driver 46, the signal processor 48, the image memory 50, the micro computer serving as the communication controller 72 or a position change monitoring unit 78, the modulator 68, the LD 52, the PD 56, and the demodulator 70) other than the LD 52. The various circuits or elements other than the LD 52 operate with the power supplied from the main power supply unit 80. A configuration having a battery (rechargeable secondary battery) built therein and supplying power to the various circuits or elements from the charged battery is suitable for the main power supply unit 80 so as not to damage the portability of the electronic cassette 12. However, the battery may employ a primary battery or may have a configuration in which it is normally connected to a commercial power source to rectify and transform the power supplied from the commercial power source and to supply the power to various circuits or elements.

The electronic cassette 12 is provided with an LD power supply 74. The LD power supply 74 is connected to a connector 76 (to be described later), operates with the power supplied from the image reader 84 through the connector 76, supplies the power supplied from the image reader 84 through the connector 76 to the LD 52, and supplies some of the power supplied from the image reader 84 to (an LD power supply 144 to be described later) the image reader 84 through the connector 76. The LD 52 of the electronic cassette 12 operates with the power supplied from the LD power supply 74. The LD power supply 74 repeatedly detects the maximum value of a supply voltage or an average voltage per unit time as a physical quantity indicating a power supply status from the image reader 84 while power is being supplied from the image reader 84 through the electrical contacts 76. When the detected physical quantity varies by a predetermined value or more or the variation rate is equal to or greater than a predetermined value, it is determined that the power supply status varies (is deteriorated in most cases) and this fact is notified to the communication controller 72.

The LD 86 of the image reader 84 is connected to a communication controller 108 through a modulator 104. The communication controller 108 is embodied by a microcomputer and serves to output transmission information to the modulator 104 at the time of transmitting information to the electronic cassette 12 and to instruct the intensity of the laser beam emitted from the LD 86 to the modulator 104. The modulator 104 modulates the laser beam emitted from the LD 86 in a predetermined modulation manner in accordance with the input transmission information and controls the driving of the LD 86 so that the intensity of the laser beam emitted from the LD 86 agrees to the instructed intensity. Accordingly, the laser beam that has been modulated in accordance with the transmission information is emitted from the LD 86 with the intensity instructed by the communication controller 108.

The PD 90 of the image reader 84 is connected to the communication controller 108 through a demodulator 106. When the external laser beam is received by the PD 90 and the received intensity signal corresponding to the received intensity of the laser beam is input from the PD 90, the demodulator 106 demodulates the information (information transmitted from an opposite communication device) carried by the received laser beam in a predetermined demodulation manner in accordance with the input received intensity signal and outputs the demodulated information to the communication controller 108. Although not shown in FIG. 6A, a lens 88 is disposed on the laser beam emission side of the LD 86 and a lens 92 is disposed on the laser beam incidence side of the PD 90.

A manipulation unit 116 is connected to the communication controller 108. As shown in FIG. 3, the manipulation unit 116 includes a display 118 disposed on the manipulation panel 130 of the main body section 94B of the casing 94 to display information including various messages and a keyboard 120 disposed similarly in the casing 94 and having plural keys. Various instructions or information input by allowing a user to manipulate the keyboards 120 is input to the communication controller 108 and the display of information on the display 118 is controlled by the communication controller 108.

An image memory 124 is connected to the communication controller 108 through an image processor 122. In the communication between the electronic cassette 12 and the image reader 84, as described later, the image data stored in the image memory 50 of the electronic cassette 12 is transmitted to the image reader 84, and the image processor 122 performs various image processes (for example, a process of removing noises from the image data or a process of correcting an image deviation of the image data due to the deviation in characteristic of the pixel units 40 of the radiation detector 26) on the image data received from the electronic cassette 12 and sequentially output from the communication controller 108 and stores the image data having been subjected to various image processes in the image memory 124.

An output controller 126 is connected to the image memory 124. The output controller 126 controls the reading of the image data from the image memory 124 and the output of the image data to an external device at the time of outputting the image data stored in the image memory 124 to the external device. A display 128 is shown as a typical example of the external device in FIG. 1. When the external device is the display 128, the image (radiographic image) indicated by the image data stored in the image memory 124 is displayed on the display 128 by the output controller 126. An example of the external device can include, in addition to the display 128, a printer printing the image indicated by the image data on a sheet-like printing medium, an information recording device recording the image data on a CD-R or a known other information recording medium, and a communication device transmitting the image data to an information processing device connected thereto through a communication network.

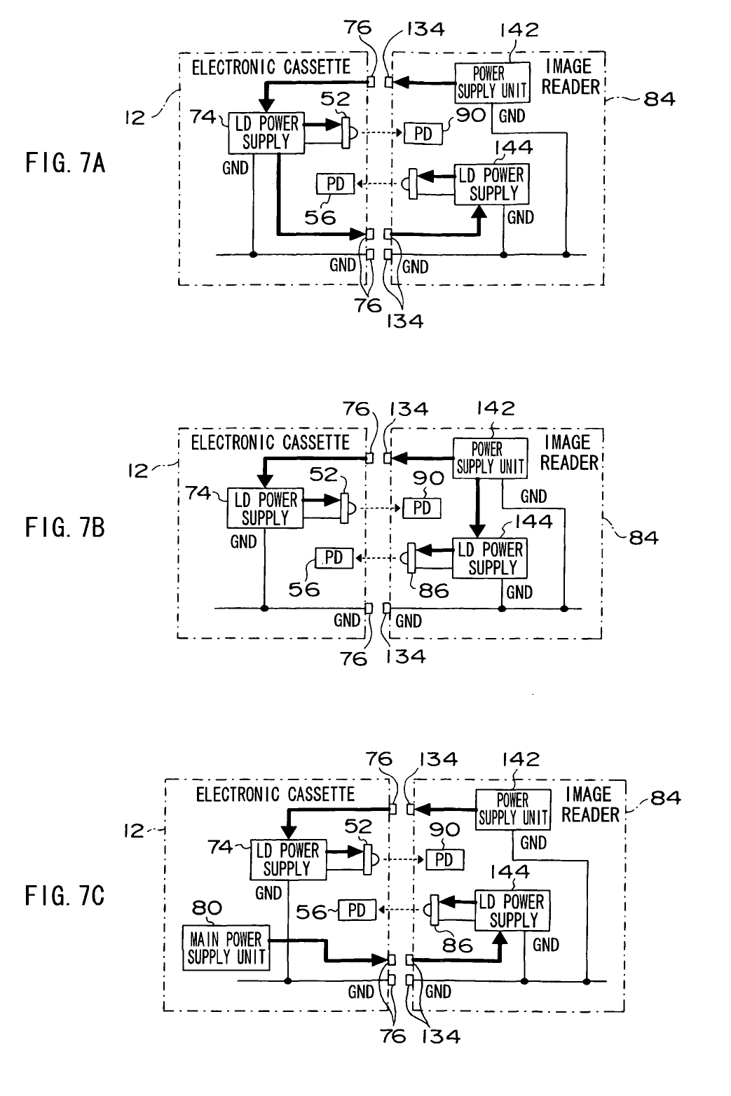

A power supply unit 142 is disposed in the image reader 84. The power supply unit 142 is normally connected to a commercial power source and serves to rectify and transform the power supplied from the commercial power source and to supply the power to various circuits or elements (the demodulator 106, the modulator 104, the PD 86, the communication controller 108, the manipulation unit 116, the image processor 112, the image memory 124, and the output controller 126) other than the LD 90 in the image reader 84. The circuits or elements other than the LD 90 in the image reader 84 and the circuits or elements other than the LD 52 operate with the power supplied from the main power supply unit 80. As shown in FIG. 7A, the power supply unit 142 is also connected to the electrical contacts 134 and also supplies the power to the LD power supply 74 of the electronic cassette 12 when the electrical contacts 76 come in electrical contact with the electrical contacts 134.

An LD power supply 144 is disposed in the image reader 84. As shown in FIG. 7A, the LD power supply 144 is connected to the electrical contacts 134 and operates to supply the power supplied through the electrical contacts 76 and 134 from the electronic cassette 12 to the LD 86 when the electrical contacts 76 come in electrical contact with the electrical contacts 134 and the power is supplied from the LD power supply 74 of the electronic cassette 12 through the electrical contacts 76 and 134. The LD 86 of the image reader 84 operates with the power supplied from the LD power supply 144. The LD power supply 144 repeatedly detects the maximum value of a supply voltage or an average voltage per unit time as a physical quantity indicating a power supply status from the image reader 84 while power is being supplied from the image reader 84 through the electrical contacts 134. When the detected physical quantity varies by a predetermined value or more or the variation rate is equal to or greater than a predetermined value, it is determined that the power supply status varies (is deteriorated in most cases) and this fact is notified to the communication controller 108.

In this embodiment, three pieces of electrical contacts 76 and 134 are disposed. As shown in FIG. 7A, one of the pieces is a power supply contact for supplying power from the power supply unit 142 of the image reader 84 to the LD power supply 74 of the electronic cassette 12, another is a power supply contact for supplying power from the LD power supply 74 of the electronic cassette 12 to the LD power supply 144 of the image reader 84, and the other is a contact for connecting a ground line GND of the electronic cassette 12 to a ground line GND of the image reader 84.

Operations of this embodiment are described below. As shown in FIG. 7A, the LD 52 of the electronic cassette 12 operates with the power supplied from the LD power supply 74 and the LD power supply 74 operates with the power supplied from the power supply unit 142 of the image reader 84 through the electrical contacts 76. The power supply to the LD power supply 74 can be performed, as described above, by inserting the casing 20 of the electronic cassette 12 up to the position (communicable position) where the bottom surface 20A of the casing 20 comes in contact with the bottom 172A of the insertion groove 172 of the image reader 84 so as to bring the electrical contacts 76 into electrical contact with the electrical contacts 134. Accordingly, the power supply to the LD 52 of the electronic cassette 12 is intercepted when the casing 20 of the electronic cassette 12 is not inserted into the insertion groove 172 of the image reader 84, thereby preventing a laser beam from being unintentionally emitted from the LD 52 of the electronic cassette 12.

As shown in FIG. 7A, the LD 86 of the image reader 84 operates with the power supplied from the LD power supply 144 and the LD power supply 144 operates with the power supplied from the LD power supply 74 of the electronic cassette 12 through the electrical contacts 134. The power supply to the LD power supply 144 can be performed, as described above, by inserting the casing 20 of the electronic cassette 12 up to the position (communicable position) where the bottom surface 20A of the casing 20 comes in contact with the bottom 172A of the insertion groove 172 of the image reader 84 so as to bring the electrical contacts 76 into electrical contact with the electrical contacts 134. Accordingly, the power supply to the LD 86 of the image reader 84 is intercepted when the casing 20 of the electronic cassette 12 is not inserted into the insertion groove 172 of the image reader 84, thereby preventing a laser beam from being unintentionally emitted from the LD 86 of the image reader 84.

When an impact or the like is applied to the casing 20 of the electronic cassette 12, a part of wirings of various circuits of the electronic cassette 12 may be short-circuited and thus power may be supplied to the LD 52. Accordingly, even when the casing 20 of the electronic cassette 12 is not inserted into the insertion groove 172 of the image reader 84, it cannot be conclusively said that the possibility of emission of a laser beam from the LD 52 is zero. On the contrary, in this embodiment, since the groove 182 (concave section) is disposed in the casing 20 of the electronic cassette 12 and the LD 52 is disposed to emit a laser beam from the side surface of the groove 182, the LD 52 is disposed so as to emit a laser beam into the groove 182 in a direction in which at least a direct beam (laser beam before being applied to and reflected from a certain member) of the emitted laser beam is not emitted to the outside of the groove 182, as can be clearly seen from the optical path 188 shown in FIG. 6B. Accordingly, even when a laser beam is emitted from the LD 52 when the casing 20 of the electronic cassette 12 is not inserted into the insertion groove 172 of the image reader 84, it is possible to prevent the direct beam having relatively great intensity from being emitted out of the groove 182.

In the groove 182 of the casing 20 of the electronic cassette 12, the opening thereof is closed with the lid section 190 when the casing 20 is not inserted into the insertion groove 172. Accordingly, even when a laser beam is emitted from the LD 52 when the casing 20 of the electronic cassette 12 is not inserted into the insertion groove 172 of the image reader 84, it is possible to prevent an indirect beam (beam applied to and reflected or diffused from a certain member) having relatively small intensity from leaking from the groove 182. In addition, by providing the lid section 190, it is possible to prevent dust from invading the groove 182.

Since the lid section 190 is maintained at the closing position where the opening of the groove 182 is closed by the biasing force from the biasing member, the lid section may rotate in the direction in which the opening of the groove 182 is opened with an application of an external force, whereby the laser beam emitted from the LD 52 may be reflected by the rotating lid section 190 and may leak from the groove 182. On the contrary, in this embodiment, the diffusing member is disposed on the almost entire surface of the inner wall surface of the groove 182 other than the portion provided with the transparent member 184 and the diffusing member is also disposed on the outer surface (the surface to which the laser beam may be applied when the lid section rotates as described above), which faces the outside of the casing 20 when the lid section is maintained at the closing position, of the lid section 190. Accordingly, even when a laser beam is emitted from the LD 52 and the lid section 190 rotates with the application of an external force when the casing 20 of the electronic cassette 12 is not inserted into the insertion groove 172 of the image reader 84, it is possible to reduce the intensity of the laser beam leaking from the groove 182, thereby securing the safety. Even when an absorbing member is provided instead of the diffusing member, the same advantage can be expected.

When an impact or the like is applied to the casing 94 of the image reader 84, a part of wirings of various circuits of the image reader 84 may be short-circuited and thus power may be supplied to the LD 86. Accordingly, even when the casing 20 of the electronic cassette 12 is not inserted into the insertion groove 172 of the image reader 84, it cannot be conclusively said that the possibility of emission of a laser beam from the LD 86 is zero. On the contrary, in this embodiment, since the insertion groove 172 (concave section) is disposed in the casing 94 of the image reader 84 and the LD 86 is disposed to emit a laser beam from the side surface of the protruding portion 178 formed upright from the insertion groove 172, the LD 86 is disposed so as to emit a laser beam into the insertion groove 172 in a direction in which at least a direct beam (laser beam before being applied to and reflected from a certain member) of the emitted laser beam is not emitted to the outside of the insertion groove 172, as can be clearly seen from the optical path 186 shown in FIG. 6A. Accordingly, even when a laser beam is emitted from the LD 86 when the casing 20 of the electronic cassette 12 is not inserted into the insertion groove 172 of the image reader 84, it is possible to prevent the direct beam having relatively great intensity from being emitted out of the insertion groove 172.

In the insertion groove 172 of the casing 94 of the image reader 84, the opening thereof is closed with the lid sections 174 when the casing 20 is not inserted into the insertion groove 172. Accordingly, even when a laser beam is emitted from the LD 86 when the casing 20 of the electronic cassette 12 is not inserted into the insertion groove 172 of the image reader 84, it is possible to prevent an indirect beam (beam applied to and reflected or diffused from a certain member) having relatively small intensity from leaking from the insertion groove 172. In addition, by providing the lid sections 174, it is possible to prevent dust from invading the insertion groove 172.

Since the lid sections 174 are maintained at the closing positions where the opening of the insertion groove 172 is closed by the biasing force from the biasing member, the lid section may rotate in the direction in which the opening of the insertion groove 172 is opened with an application of an external force, whereby the laser beam may leak from the insertion groove 172. On the contrary, in this embodiment, the diffusing member is disposed on the almost entire surface of the inner wall surface of the insertion groove 172 other than the portion provided with the protruding portion 178. Accordingly, even when a laser beam is emitted from the LD 86 and the lid sections 174 rotate with the application of an external force when the casing 20 of the electronic cassette 12 is not inserted into the insertion groove 172 of the image reader 84, it is possible to reduce the intensity of the laser beam leaking from the insertion groove 172, thereby securing the safety. When an absorbing member is provided instead of the diffusing member, the same advantage can be expected.

When a user intends to display the image data, which is stored in the image memory 50 of the electronic cassette 12 by taking a radiological image, as an image on the display 128, the user first grasps the casing 20 of the electronic cassette 12 storing the image data to be read so that the bottom surface 20A is directed downward and then moves the casing to a space above the insertion groove 172 of the image reader 84. Then, the user inserts the lower end portion (portion close to the bottom surface 20A) of the casing 20 of the electronic cassette 12 into the insertion groove 172 of the image reader 84, and then moves down the casing 20 until the bottom surface 20A of the casing 20 of the electronic cassette 12 comes in contact with the bottom 172A of the insertion groove 172 of the image reader 84.

In this case, since the lid sections 174 come in pressing contact with the corners coming contact with the bottom surface 20A of the casing 20, as shown in FIGS. 4B and 4C, the lid sections 174 rotate in the direction in which the opening of the insertion groove 172 is opened against the biasing force from the biasing member which is not shown and thus the lower end portion of the casing 20 can be inserted into the insertion groove 172. When the bottom surface 20A of the casing 20 gets close to the bottom 172A of the insertion groove 172, the lid section 190 comes in pressing contact with the corners of the protruding portion 178. Accordingly, as shown in FIGS. 6C and 6D, the lid section 190 rotates in the direction where the opening of the groove 182 is opened against the biasing force from the biasing member which is not shown and thus the protruding portion 178 of the casing 20 can be inserted into the groove 182.

When the bottom surface 20A of the casing 20 reaches the communicable position where it comes in contact with the bottom 172A of the insertion groove 172 (the state shown in FIG. 3B), the LD 52 of the electronic cassette 12 is opposed to the PD 90 of the image reader 84 and the LD 86 of the image reader 84 is opposed to the PD 56 of the electronic cassette 12 with the transparent members 180 and 184 interposed therebetween (the state where the radio communication can be made using the laser beam). At this time, the electrical contacts 134 come in electrical contact with the electrical contacts 76, respectively. When the electrical contacts 134 are electrically connected to the electrical contacts 76, the power is supplied to the LD power supply 74 of the electronic cassette 12 through the electrical contacts 76 and 134 from the power supply unit 142 of the image reader 84 and thus the LD 52 of the electronic cassette 12 can emit a laser beam. Some of the power supplied to the LD power supply 74 from the power supply unit 142 is supplied to the LD power supply 144 of the image reader 84 through the electrical contacts 76 and 134 and thus the LD 86 of the image reader 84 can also emit a laser beam.

When a user sets the electronic cassette 12 to the image reader 84 (positions the electronic cassette at the communicable position), the user instructs the image reader 84 to read the image data from the electronic cassette 12 by manipulating the keyboard 120 of the manipulation unit 116.

When it is instructed to read the image data, the communication controller 108 of the image reader 84 allows the LD 86 to emit a laser beam having minute intensity through the modulator 104. The laser beam having minute intensity emitted from the LD 86 is incident on the PD 56 of the electronic cassette 12 through the transparent members 180 and 184. When the laser beam is detected (sensed) by the PD 56, the communication controller 72 of the electronic cassette 12 allows the LD 52 to emit a laser beam having minute intensity through the modulator 68. The laser beam having minute intensity emitted from the LD 52 is incident on the PD 90 of the image reader 84 through the transparent members 180 and 184.

When the laser beam is detected (sensed) by the PD 90 of the image reader 84, the small-power laser beam emitted from the LD 86 of the image reader 84 is detected (sensed) by the PD 56 of the electronic cassette 12 and the small-power laser beam emitted from the LD 52 of the electronic cassette 12 is detected (sensed) by the PD 90 of the image reader 84. Accordingly, it can be determined that the relative position between the electronic cassette 12 and the image reader 84 is the optimal communicable position at which the laser beam emitted from the LD 86 is input to the center of the light-receiving surface of the PD 56 or the vicinity thereof and the laser beam emitted from the LD 52 is input to the center of the light-receiving surface of the PD 90 or the vicinity thereof.

Therefore, when the small-power laser beam is detected (sensed) by the PD 90, the communication controller 108 of the image reader 84 performs an opposite device checking process of checking whether the opposite device is a regular device by transmitting predetermined information from the relevant device using a laser beam (modulating the laser beam emitted from the LD of the relevant device in accordance with the predetermined information) and confirming the details of the information (information obtained by demodulating the laser beam emitted from the LD of the opposite device and received by the PD of the relevant device) received from the opposite device using the laser beam. An example of the information transmitted from the electronic cassette 12 to the image reader 84 in the opposite device checking process can include information such as a cassette ID for identifying the electronic cassette 12 and an example of the information transmitted from the image reader 84 to the electronic cassette 12 can include information indicating that the relevant device is an image reader.

The communication controller 108 of the image reader 84 performs an error process of stopping the emission of the laser beam from the LD 86 and displaying on the display 118 an error message indicating that the opposite device is not a regular device when determining that the opposite device is not a regular device in the opposite device checking process, or sets the power of the laser beam from the LD 86 to a value of the normal communication and transmits information requesting the opposite device for transmitting data to the opposite device using the laser beam when determining that the opposite device is a regular device (the electronic cassette 12) in the opposite device checking process.

When receiving the information requesting for transmitting data from the image reader 84, the communication controller 72 of the electronic cassette 12 sets the power of the laser beam from the LD 52 to the value of the normal communication, reads image data, which is not transmitted to the image reader 84, as the image data to be transmitted from the image memory 50, and transmits the image data read from the image memory 50 to the opposite device (the image reader 84) using a laser beam. When the image data transmitted from the electronic cassette 12 using the laser beam is received by the image reader 84, the communication controller 108 of the image reader 84 outputs the image data received from the opposite device (the electronic cassette 12) to a rear stage (the image processor 122 in this embodiment). Accordingly, the image data received by the image reader 84 is subjected to various image processes by the image processor 122 and then is stored in the image memory 124. The communication controller 108 of the image reader 84 transmits a response to the transmission of data from the opposite device (the electronic cassette 12) using a laser beam. When the response is received by the electronic cassette 12, the communication controller 72 of the electronic cassette 12 performs again the reading of non-transmitted image data from the image memory 50 and the transmitting of the read image data.

The above-mentioned sequence is repeated until the image data not transmitted to the image reader 84 does not remain in the image memory 50 and all the non-transmitted image data stored in the image memory 50 is transmitted to the image reader 84. When the non-transmitted image data does not remain in the image memory 50, the communication controller 72 of the electronic cassette 12 notifies the opposite device (the image reader 84) of the end of data transmission and stops the emission of the laser beam from the LD 52. When the end of data transmission is notified, the communication controller 108 of the image reader 84 stops the emission of the laser beam from the LD 86 and displays a message indicating that the reading of image data from the electronic cassette 12 is ended on the display 118.

As described above, when an external force is applied to at least one of the casing 20 of the electronic cassette 12 and the casing 94 of the image reader 84 in communication between the electronic cassette 12 and the image reader 84 and the contact state between the electrical contacts 76 and the electrical contacts 134 varies (for example, when the electrical contacts 76 and the electrical contacts 134 come in slight contact with each other and thus the contact resistance therebetween increases), at least one of the power supply state to the LD power supply 74 and the power supply state to the LD power supply 144 varies and the variation in power supply state is detected by at least one of the LD power supply 74 and the LD power supply 144.

When the variation in power supply state is detected by the LD power supply 74, the detected variation in power supply state is notified to the communication controller 72. In this case, the communication controller 72 stops the emission of the laser beam from the LD 52 at once. The stop of emission of a laser beam from the LD 52 can be carried out by stopping the power supply from the LD power supply 74 to the LD 52 or stopping the output of signals from the modulator 68 to the LD 52. Accordingly, even when the external force applied to at least one of the casing 20 of the electronic cassette 12 and the casing 94 of the image reader 84 is great enough to cause the separation of the electronic cassette 12 from the insertion groove 172 of the image reader 84, it is possible to stop the emission of a laser beam from the LD 52 before the electronic cassette 12 is actually separated from the insertion groove 172, thereby preventing the laser beam emitted from the LD 52 from leaking out of the casing 20 (out of the groove 182) in advance.

When the variation in power supply state is detected by the LD power supply 144, the detected variation in power supply state is notified to the communication controller 108. In this case, the communication controller 108 stops the emission of the laser beam from the LD 86 at once and performs an error process of displaying an error message on the display 118. The stop of emission of a laser beam from the LD 86 can be carried out by stopping the power supply from the LD power supply 144 to the LD 86 or stopping the output of signals from the modulator 104 to the LD 86. Accordingly, even when the external force applied to at least one of the casing 20 of the electronic cassette 12 and the casing 94 of the image reader 84 is great enough to cause the separation of the electronic cassette 12 from the insertion groove 172 of the image reader 84, it is possible to stop the emission of a laser beam from the LD 86 before the electronic cassette 12 is actually separated from the insertion groove 172, thereby preventing the laser beam emitted from the LD 86 from leaking out of the groove 172 in advance.

Even when the control for stopping the emission of a laser beam based on the variation in power supply state is late due to the rapid separation of the casing 20 of the electronic cassette 12 from the communicable position in communication between the electronic cassette 12 and the image reader 84, the electrical contact between the electrical contacts 76 and 134 is released at the same time as separating the casing 20 of the electronic cassette 12 and the power supply from the power supply unit 142 of the image reader 84 to the LD power supply 74 of the electronic cassette 12 and the power supply from the LD power supply 74 of the electronic cassette 12 to the LD power supply 144 of the image reader 84 are also stopped. Accordingly, the power supply to the LDs 52 and 86 is stopped and thus the emission of a laser beam from the LDs 52 and 86 is also stopped. When the casing 20 of the electronic cassette 12 is separated from the communicable position in communication with electronic cassette 12, the stop of power supply is notified from the LD power supply 144 to the communication controller 108 and the error process of displaying an error message on the display 118 is performed.

Although it has been described above as show in FIG. 7A that the power is supplied from the power supply unit 142 of the image reader 84 to the LD power supply 74 of the electronic cassette 12 through the electrical contacts 76 and 134 and a part of the power supplied to the LD power supply 74 is supplied to the LD power supply 144 of the image reader 84 through the electrical contacts 76 and 134, the invention is not limited to this configuration. For example, as shown in FIG. 7B, a configuration may be employed in which the power is supplied from the power supply unit 142 of the image reader 84 to the LD power supply 74 of the electronic cassette 12 through the electrical contacts 76 and 134 and the power is supplied from the power supply unit 142 of the image reader 84 to the LD power supply 144 of the image reader 84 through the power supply line in the image reader 84. For example, as shown in FIG. 7C, a configuration may be employed in which the power is supplied from the power supply unit 142 of the image reader 84 to the LD power supply 74 of the electronic cassette 12 through the electrical contacts 76 and 134 and the power is supplied from the main power supply unit 80 of the electronic cassette 12 to the LD power supply 144 of the image reader 84 through the electrical contacts 76 and 134.

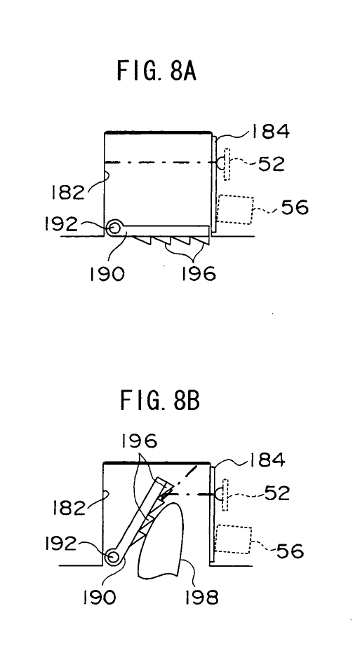

Although it has been described that the diffusing member or the absorbing member is disposed on the outer surface, which faces the outside of the casing 20 when it is maintained at the closing position (see FIG. 6B), of the lid section 190, the invention is not limited to the configuration. For example, as shown in FIGS. 8A and 8B, when the lid section 190 is made to rotate up to the position where the laser beam emitted from the LD 52 is applied to the outer surface, the outer surface of the lid section 190 may be shaped to reflect the applied laser beam in a direction in which the laser beam is not emitted out of the groove 182. In the example shown in FIGS. 8A and 8B, a reflecting member 196 having a vertical surface substantially perpendicular to the outer surface and a slope oblique about the outer surface is continuously formed. In this example, when the lid section 190 is made to rotate from the position (state shown in FIG. 8A) where the opening of groove 182 is closed with the lid section 190 to the position where the laser beam emitted from the LD 52 is applied to the outer surface of the lid section 190 by an object 198 (for example, a user's finger tip) as shown in FIG. 8B, the laser beam applied to the outer surface of the lid section 190 can be reflected to the bottom of the groove 182 by the reflecting member 196, thereby reducing the laser beam leaking from the groove 182. The shape of the reflecting member 196 is not limited to the shape shown in FIGS. 8A and 8B, but any shape can be employed as long as it can reflect the applied laser beam in the direction in which the laser beam is not emitted out of the groove 182.

Although it has been described that the electronic cassette 12 and the image reader 84 as the electronic devices according to the invention emit a laser beam to communicate with each other, one of the devices making a communication may emit a laser beam to transmit information and the other may transmit information by the use of an additional communication unit (for example, infrared). In this case, considering that a very high transfer rate is embodied in the radio communication using an infrared laser beam, an device (for example, the electronic cassette transmitting image data among the electronic cassette and the image reader) transmitting a greater amount of information is preferably selected as the device emitting a laser beam to transmit information.

Although the electronic cassette 12 (a portable radiographic image converter) and the image reader 84 have been exemplified as a suitable electronic device according to the invention, the invention is not limited to the devices, but may be applied to any electronic device making a radio communication with another device. Particularly, considering that a very high transfer rate is embodied in the radio communication using an infrared laser beam, the invention can be suitably applied to electronic devices of which at least one has the portability and which transmit and receive a great amount of data by the radio communication or have a high need for transmitting and receiving a great amount of data. For example, an image pickup apparatus such as a digital still camera or a digital video camera and an apparatus such as a PC or printer receiving still image data or moving image data from the image pickup apparatus may be selected as the electronic devices according to the invention and the radio communication therebetween may be made using a laser beam. A scanner having the portability and an apparatus such as a PC or a printer receiving still image data from the scanner may be selected as the electronic devices according to the invention and the radio communication therebetween may be made using a laser beam. Portable devices (such as mobile phone or PDA) having at least one of a function of taking a still image or a moving image and a function of reproducing music may be selected as the electronic devices according to the invention and the radio communication for exchanging image data or music data between the portable devices may be made using a laser beam.

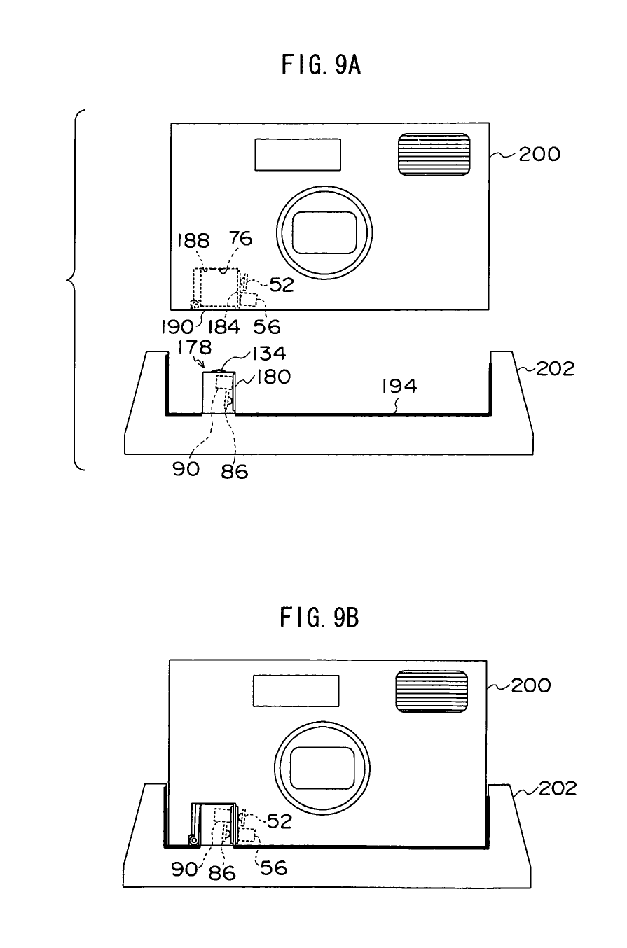

For example, as the electronic apparatuses according to the invention, a digital still camera 200 and a cradle 202 into which the digital still camera 200 is set at the time of reading image data from the digital still camera 200 or charging a built-in battery of the digital still camera 200 are employed in FIGS. 9A and 9B. In this example, by allowing the LDs 52 and 86 to operate with the power supplied from the opposite apparatus through the electrical contacts 76 and 134, it is possible to secure the safety when the relative position to the opposite apparatus is not proper.

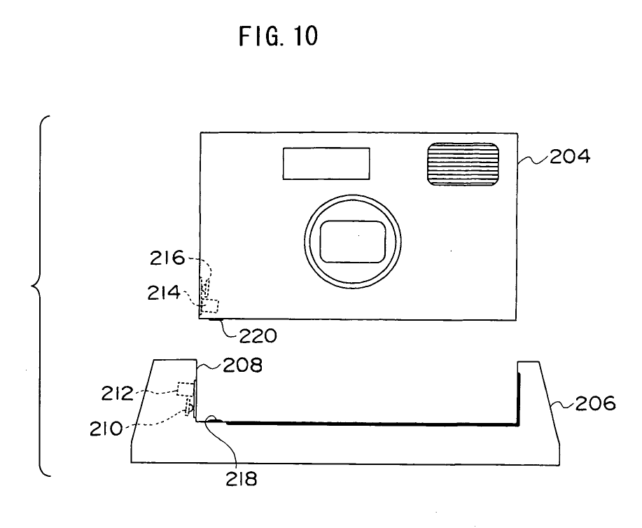

Although it has been described that the protruding portion 178 is formed upright in the insertion groove 172 of the casing 94 of the image reader 84, the groove 182 is formed in the casing 20 of the electronic cassette 12, the LD 86, the PD 90, and the electrical contacts 134 are disposed in the protruding portion 178, the LD 52 and the PD 56 are disposed on one side of the groove 182, and the electrical contacts 76 are disposed on the bottom of the groove 182, the invention is not limited to this configuration. For example, as shown in FIG. 10, the convex portion such as the protruding portion 178 and the concave portion such as the groove 182 may be omitted, an LD 210 and a PD 212 may be disposed in a direction, in which at least a direct beam of laser beams emitted from the LD 210 is not emitted out of a concave section 208, on the side wall of the concave section 208 which is formed in a casing of a first electronic apparatus (a cradle 206 in the example shown in the FIG. 10) and which a casing of a second electronic apparatus (a digital still camera 204 in the example shown in FIG. 10) is inserted into, and a PD 214 and an LD 216 may be disposed at positions, which are opposed to the LD 210 and the PD 212 when the casing is set in the concave section 208, of the casing of the second electronic apparatus. In this case, electrical contacts 218 of the first electronic apparatus can be disposed on the bottom of the concave section 208 and electrical contacts 220 of the second electronic apparatus can be disposed at positions, which correspond to the electrical contacts 218, on the bottom of the casing.

In the above-embodiment, since the protruding portion 178 and the groove 182 are disposed at asymmetric positions, it is possible to prevent the casing 20 of the electronic cassette 12 from being inserted into the insertion groove 172 with the front and back surfaces thereof inverted. However, as show in FIG. 10, when the convex portion such as the protruding portion 178 and the concave section such as the groove 182 are omitted, for example, it is not possible to prevent the casing of the second electronic apparatus from being inserted into the concave section 208 in the inverted direction, but to prevent the laser beams from being emitted from the LDs 210 and 216 in the casing of the second electronic apparatus is inserted into the concave section 208 in the inverted direction, by disposing the electrical contacts 218 and 220 at asymmetric positions.

1. An electronic apparatus comprising:
a housing that has a first concave section;
a first emission unit that emits a laser beam into the first concave section; and
a first modulator that modulates the laser beam emitted from the first emission unit in accordance with transmission information,
wherein the first emission unit is disposed so as not to emit at least a direct beam of the emitted laser beam to the outside of the first concave section.

2. An electronic apparatus comprising:
a first apparatus comprising a housing that has a first concave section, a first emission unit that emits a laser beam into the first concave section, and a first modulator that modulates the laser beam emitted from the first emission unit in accordance with transmission information; and
a second apparatus comprising a housing and a reception unit,
wherein when a relative position between the housing of the first apparatus and the housing of the second apparatus is adjusted to a communicable position where the laser beam emitted from the first emission unit is incident on a light-receiving area of the second apparatus, the reception unit of the second apparatus receives the transmission information by detecting the laser beam incident on the light-receiving area and demodulating the transmission information from the detection result of the laser beam, wherein:
the first emission unit is disposed so as not to emit at least a direct beam of the emitted laser beam to the outside of the first concave section; and
the light-receiving area of the second apparatus is disposed in a portion, which is inserted into the first concave section and to which the laser beam emitted from the first emission unit is applied, in the housing of the second apparatus when the relative position between the housing of the second apparatus and the housing of the first apparatus is adjusted to the communicable position.

3. The electronic apparatus according to claim 1, wherein the first emission unit is disposed so as to emit the laser beam along an optical path where a distance between the optical path and a bottom surface of the first concave section decreases as the laser beam moves away from the first emission unit.

4. The electronic apparatus according to claim 2, wherein the first emission unit is disposed so as to emit the laser beam along an optical path where a distance between the optical path and a bottom surface of the first concave section decreases as the laser beam moves away from the first emission unit.

5. The electronic apparatus according to claim 1, wherein at least a part of the inner surface of the first concave section comprises one of a diffusing member that diffuses the reflected beam of the applied laser beam by reflecting the applied laser beam in a plurality of directions that are different from each other or an absorbing member that absorbs at least a part of the applied laser beam.

6. The electronic apparatus according to claim 2, wherein at least a part of the inner surface of the first concave section comprises one of a diffusing member that diffuses the reflected beam of the applied laser beam by reflecting the applied laser beam in a plurality of directions that are different from each other or an absorbing member that absorbs at least a part of the applied laser beam.

7. The electronic apparatus according to claim 2, wherein the housing of the first apparatus comprises a lid section which is displaced to a retreating position where the opening of the first concave section is opened by being pressed via the housing of the second apparatus when the housing of the second apparatus is inserted into the first concave section and which is displaced to a closing position where the opening of the first concave section is closed by biasing force from an biasing member when the housing of the second apparatus is separated from the first concave section.

8. The electronic apparatus according to claim 7, wherein the lid section, to which the laser beam may be applied when the laser beam is emitted from the first emission unit when the housing of the second apparatus is not inserted into the first concave section and the lid section is located at the retreating position or in the vicinity thereof by being pressed via an object other than the housing of the second apparatus, is shaped to reflect the laser beam in a direction in which the laser beam is not emitted to the outside of the first concave section.

9. The electronic apparatus according to claim 7, wherein the lid section, to which the laser beam may be applied when the laser beam is emitted from the first emission unit when the housing of the second apparatus is not inserted into the first concave section and the lid section is located at the retreating position or in the vicinity thereof by being pressed via an object other than the housing of the second apparatus, comprises one of a diffusing member that diffuses the reflected beam of the applied laser beam by reflecting the applied laser beam in a plurality of directions that are different from each other or an absorbing member that absorbs at least a part of the applied laser beam.

10. The electronic apparatus according to one of claim 2, wherein the second apparatus comprises a second emission unit that emits a laser beam and a second modulator that modulates the laser beam emitted from the second emission unit in accordance with the transmission information, and the second apparatus performs bidirectional communication with the first apparatus using the laser beam,
wherein the laser beam emitted from the second emission unit of the second apparatus is incident on a light-receiving area of the first apparatus when the relative position between the housing of the second apparatus and the housing of the first apparatus is adjusted to the communicable position, and
wherein the first apparatus comprises a reception unit that receives the transmission information from the second apparatus by detecting the laser beam incident on the light-receiving area of the first apparatus and demodulating the transmission information from the detection result of the laser beam when the relative position between the housing of the second apparatus and the housing of the first apparatus is adjusted to the communicable position.

11. The electronic apparatus according to claim 10, wherein a second concave section is disposed in a portion, which is inserted into the first concave section, of the housing of the second apparatus when the relative position between the housing of the second apparatus and the housing of the first apparatus is adjusted to the communicable position, the light-receiving area of the second apparatus is disposed in the second concave section, and the second emission unit is disposed so as not to emit at least a direct beam of the emitted laser beam to the outside of the second concave section but to emit the laser beam into the second concave section, and
wherein a convex portion which is inserted into the second concave section when the relative position between the housing of the second apparatus and the housing of the first apparatus is adjusted to the communicable position is disposed in the first concave section of the housing of the first apparatus, the light-receiving area of the first apparatus is disposed in the convex portion in the first concave section, and the first emission unit is disposed to emit the laser beam from the convex portion in the first concave section to the light-receiving area of the second apparatus.

12. The electronic apparatus according to claim 1, wherein the laser beam is an invisible laser beam having a wavelength outside the visible region.

13. The electronic apparatus according to claim 2, wherein the laser beam is an invisible laser beam having a wavelength outside the visible region.

14. The electronic apparatus according to claim 12, wherein the invisible laser beam is a laser beam with a wavelength in the infrared region.

15. The electronic apparatus according to claim 13, wherein the invisible laser beam is a laser beam with a wavelength in the infrared region.

16. The electronic apparatus according to any one of claim 1, wherein the electronic apparatus is one of an image pickup apparatus, a portable information apparatus, a portable radiographic image converter, or an image reader that reads image information from a portable radiographic image converter.

17. The electronic apparatus according to any one of claim 2, wherein the electronic apparatus is one of an image pickup apparatus, a portable information apparatus, a portable radiographic image converter, or an image reader that reads image information from a portable radiographic image converter.
